(19) United States
(12) Patent Application Publication
(10) Pub. No.: US 2010/0250616 A1
(43) Pub. Date: Sep. 30, 2010

(54) MEMORABILIA REGISTRY SYSTEM

(76) Inventor: Richard C. Kim, Phoenix, AZ (US)

Correspondence Address: DUBOIS, BRYANT, CAMPBELL & SCHWARTZ, LLP, 700 LAVACA STREET, SUITE 1300, AUSTIN, TX, 78701, US

(21) Appl. No.: 12/730,882

(22) Filed: Mar. 24, 2010

Related U.S. Application Data
(60) Provisional application No. 61/162,910, filed on Mar. 24, 2009.
(60) Provisional application No. 61/244,315, filed on Sep. 21, 2009.

(51) Int. Cl. G06F 17/30

(52) U.S. Cl. 707/802; 707/E17.005

(57) ABSTRACT

A memorabilia registry system in which information regarding an item, such as the signer, a list of all signers, or authentication of signature, is initially entered into the registry with a time stamp and additional information about the item may also be added over the life of the item. The information in the registry can provide authentication of an item's past and can be useful in establishing the chain of title. One method of authenticating a signature is through the use of a biometric pen. The biometric pen authenticates the “way” something is signed (i.e. the multi-dimensional data captured from the pen's tilt, speed, pressure all over time, date of signing, time of signing, specific pen used to sign, etc.) rather than the “image” of the signature, making it much more difficult to counterfeit.

### CROSS-REFERENCE TO A RELATED APPLICATION

This non-provisional application claims priority based upon prior U.S. Provisional Patent Application Ser. No. 61/162,910 filed Mar. 24, 2009 in the name of Richard C. Kim, entitled “Writing System and Light Apparatus,” the disclosure of which is incorporated in its entirety herein by this reference, and U.S. Provisional Patent Application Ser. No. 61/244,315 filed Sep. 21, 2009 in the name of Richard C. Kim, entitled “Memorabilia Registry System,” the disclosure of which is also incorporated in its entirety herein by this reference.

### BACKGROUND OF THE INVENTION

The memorabilia industry experienced tremendous growth over the last 25 years. The sports collectibles industry alone exceeds $2 billion in sales annually with more than 16.7 million collectors worldwide. Over the past decade, the industry has experienced explosive growth as sports fans have realized a new way to enjoy their favorite sports by collecting trading cards and autographed memorabilia.

In the mid-1980s the industry began to skyrocket as rookie cards of baseball stars such as Roger Clemens, Kirby Puckett and Don Mattingly generated mass interest. Shortly thereafter, a similar phenomenon occurred with football, basketball and hockey cards. At the same time, the number of card manufacturers jumped from three to over thirty and interest in retired stars grew as cards, autographs and memorabilia of Mickey Mantle, Babe Ruth and other legends soared in value.

In cities around the country, consumer shows for sports collectors are featured nearly every weekend. Consumer shows in general have experienced significant increases in attendance in recent years, and sports collectible shows in particular are growing at an even faster rate, with activities and attractions for all members of the family. As these shows have broadened their offerings beyond just celebrity appearances and corporate participation has increased, the result has been better-produced shows and more and more people returning to these shows year after year. Correspondingly, the amount of online trading activities is increasing exponentially.

The FBI reports that 70% of all autographed sports memorabilia is counterfeit. In order to counter such surge of counterfeit goods, many manufacturers and suppliers of the autographed memorabilia attempt to authenticate their items through a variety of methods. One of the early pioneer and the most imitated method is the Upper Deck Authentication in which a representative witnesses the event and a holographic label is attached to the autographed item and to a corresponding certificate. Some other methods are used for authentication such as synthetic DNA-laced ink, verifiable using a proprietary infrared laser, or provide some video recording of the signing sessions.

### SUMMARY OF THE INVENTION

Memorabilia preserves the memory of the moment. A great deal of time, money and energy are expended each year authenticating the signatures of celebrities. However, the expense associated with human witnesses and signature authentication increases the cost of the memorabilia dramatically. For example, it is common for one of the most crucial elements in verifying a signature, the exact time and location where the item was signed, to be omitted from the memorabilia or the registry. Similarly, it is not uncommon for the “chain-of-custody” of the item from its creation through each subsequent transfer of ownership to be missing or incomplete.

In one embodiment, the authentication system of the present invention captures and verifies the signing event without the need for a human witness. The signature authentication is included in a memorabilia registry that is self-contained so that any collector or dealer can quickly, conveniently and confidently authenticate an item. The authentication system of the present invention can capture and preserve all or any parts of the following to give unique attributes to individual items: the biometric signature of the signer with automatic verification; the time and place (IP address) of the exact signing moment of each signature and item; video, sound and/or photographs of the signing moment; and details of the item such as private descriptions and close-up photographs.

Each item can be uniquely identified within the memorabilia database through (1) the inherent features of the item and (2) the unique event recordings (e.g. time of signing, place of signing, detailed photographs, etc.) attached to that item. The attributes within the memorabilia database cannot be reused since they are unique to each item. Therefore, if there are similar items within the database, the authentic item is the one with all the original attributes registered in the database that was created at the earliest time and with the earliest established item ID.

One method of capturing the biometric signature of a signer is through the use of a biometric pen. The biometric pen authenticates the “way” something is signed (i.e. the multi-dimensional data captured from the pen's tilt, speed, pressure all over time) rather than the “image” of the signature. This is significant because it is tremendously more difficult to copy the act of signing one's signature than to copy the image of an autograph. The act of signing creates thousands of data points which can be compared to a digital signature pattern. This biometric pen can be connected to a computer and after a registration, which could involve two or three sequential signings by the signer, that signature would available for verification using any computer connected to the Internet.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a flow diagram depicting the process of adding information regarding memorabilia into the registry;

FIG. 2 shows one embodiment of a video capture screen in which a video of the signing event is captured online; and

FIG. 3 shows one embodiment of a web page showing a registered user's items in the registry.

### DETAILED DESCRIPTION OF THE PREFERRED EMBODIMENT

The present invention provides an improved method and system for the registration and authentication of memorabilia. The making and using of the presently preferred embodiments are discussed in detail below. It should be appreciated, however, that the present invention provides many applicable inventive concepts that can be embodied in a wide variety of specific contexts. For example, while the method and system are described herein for memorabilia, memorabilia shall be deemed to include any item of value, whether signed or unsigned. Accordingly, the specific embodiments discussed are merely illustrative of specific ways to make and use the invention, and do not limit the scope of the invention.

Also, the distinction between a registry and a database is relevant in this context. The Cambridge Dictionary of the English Language defines a registry as “a place where official records are kept.” In this case, the official records include an items history and verification of any autographs and or historically significant events in which the item was involved. Again, it is not important that the item be signed, only that the item has been involved in an event of interest. These official records in the memorabilia registry can be used to verify the ownership and chain of title of the item.

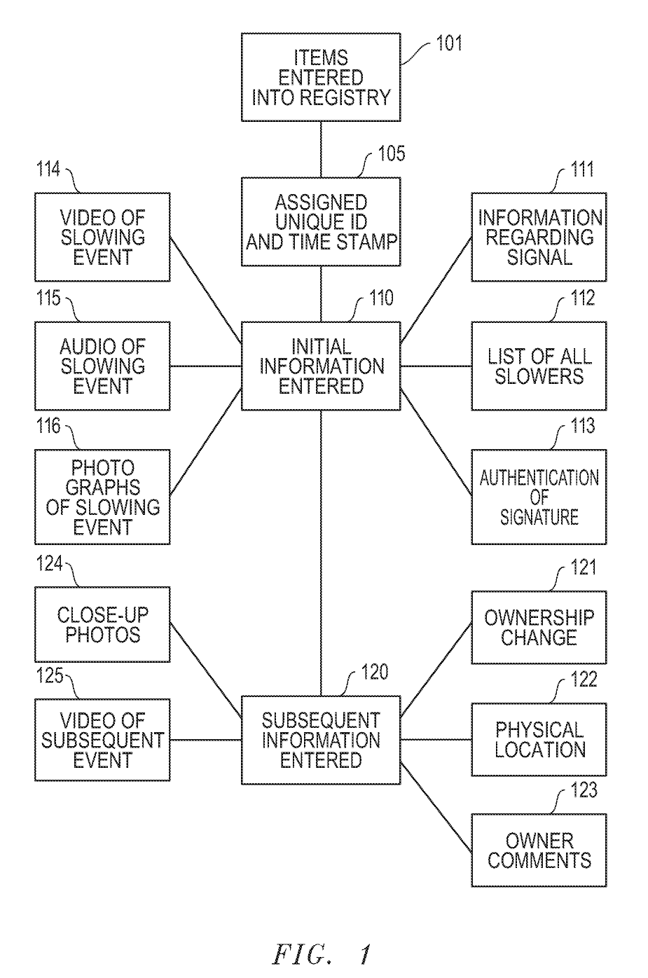

Referring now to the drawings. As depicted in FIG. 1, an item is initially entered 101 into the memorabilia registry and, at that time, the item is assigned a unique item ID and a time stamp is associated with the entry 105. This creates a trusted third party registry of the item and its unique item number.

Once the item has been initially entered 101 into the registry, additional information about the item may also be added. This information may be added immediately after the initial entry 101 or, for the reasons described later, over the life of the item. For example, immediately after the initial entry 101, it may be useful to add information 110 regarding the signer 111, a list of all signers 112, authentication of signature 113 which is discussed in more detail below, video of the signing event 114, audio of the signing event 115, photographs of the signing event 116, and other similar information. It may also be useful to include historic videos of the item signed such as, for example, video of a historic play in a football game associated with the football signed by the athlete or athletes involved in the play. Similarly, the owner of the item may want to include a written description of the significance of the item, certificates, and other relevant information.

One unique and advantageous aspect of the present invention is the ability to include files that contain information regarding the history of the item. For example, as time passes, additional information may be added 120 to the registry and each subsequent entry can include a time stamp. This will aid in the authentication of the entire item, not just the autograph. This type of information may include ownership changes 121, physical location of the item 122, owner comments 123, close-up photographs showing any changes in condition of the item 124, or video of the item receiving public recognition 125. In addition to providing a chain of title for the item as discussed in more detail below, this event history can be very useful in ascertaining the condition of an item, or the deterioration of an item, over time.

Another aspect of certain embodiments of the present invention is that it is not simply a signature verification database. The registry can be used in connection with any item of historical interest, even items that have not been signed. For example, in the case of a set of shoes worn by Michael Jordan on certain game day, the initial information 110 that could be added could include the date of the game, the name of the opponent, Michael Jordan's game statistics, the method by which the shoes were acquired, etc. Similarly, in the case of a classic car, the initial information 110 could include its history, maintenance, ownership, and any changes made to the car which make it unique. In each of these cases, the unique item ID could be considered a “Memorabilia Identification Number” and every single piece of identifiable collectable items could have its own unique number.

In some embodiments, including an item in the memorabilia registry includes authenticating the signature 113. There are numerous methods of authenticating a signature. In one embodiment of the present invention, authentication is achieved through the use of a biometric pen. The biometric pen authenticates the “way” something is signed (i.e. the multi-dimensional data captured from the pen's tilt, speed, pressure all over time, date of signing, time of signing, specific pen used to sign, etc.) rather than the “image” of the signature. This is significant because it is substantially more difficult to replicate the act of signing one's signature than to copy the image of an autograph. The act of signing one's signature creates thousands of data points which can be used to create a digital signature pattern. This biometric pen can be connected to a computer and after a signer is registered, which could involve two or three sequential signings by the signer, that signer's digital signature pattern would be available for verification using any computer connected to the Internet. This type of authentication is both time specific and unit specific. For example, an indelible marker could be used in a biometric pen to sign twenty jerseys which have been pre-numbered 1-20. Each autographed jersey can be authenticated as having been signed on a specific date and time with a specific pen. Each memorabilia unit can then be delivered with a contemporaneously generated, unique (as to unit number e.g. 5/20) authentication certificate.

Unlike other systems, there is no need for a session certificate or a third party authenticator with the biometric pen. The data generated by the biometric pen is sufficient to verify the authenticity of the signature. The biometric pen can capture the complete pen motion data while signing, and the pen system can automatically evaluate the data to provide signer authentication and verification of each signature. A biometric pen can work on any surface and any material, including convex items like basketballs and baseballs. There is no need for the holographic label and the authenticity and trace-ability of an item does not depend on the label.

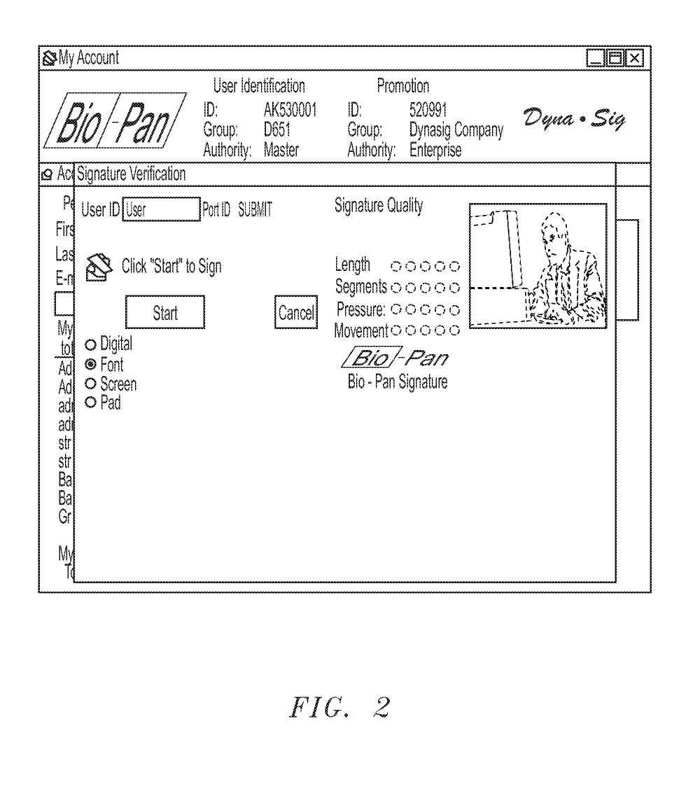

In addition to the biometric pen, there are a number of other ways of authenticating a signature which may be included in the memorabilia registry. For example, while the celebrity signs the object, a still picture, an audio track, or a video recordings may be simultaneously captured with the signature data and stored in the registry. FIG. 2 depicts one embodiment of a video capture screen in which a video of the signing event is captured online. In this manner, as with the biometric pen, the signer makes no additional time investment and can sign as quickly as he or she desires.

As previously discussed, in some embodiments information regarding ownership 121 may be included in the memorabilia registry. When a memorabilia unit is transferred, the new information regarding ownership 121 is updated so that the provenance of the item can be maintained and counterfeiting can be avoided. Each unique item ID is associated with a single item so that item's registration and ownership is tracked from the time the item is entered into the memorabilia registry through any subsequent sale or transfer. As an option, a transfer can be logged by the buyer and seller using the registry, increasing and maintaining the value of the memorabilia since the item's title is traceable through each owner. As a result, the chain of title is easily verifiable.

In those instances where the ability to view an item is limited to the owner, it can be more difficult to transfer the item to a potential buyer who desires to see, and authenticate, the item prior to purchase. In these cases, the registry may have an escrow option in which the item is placed into escrow temporarily so that the potential buyer, but not the general public, is able to view the item and all of the entries relating to the item. Once the item is in escrow, the potential buyer can use the information in the registry to make decisions regarding the purchase of the item. If the buyer elects to purchase the item, the buyer and the seller can authorize the transfer out of escrow to the buyer's account. If the buyer elects not to purchase the item, or if the seller elects not to sell the item for any reason, the item will be removed from escrow and will return solely to the seller's account.

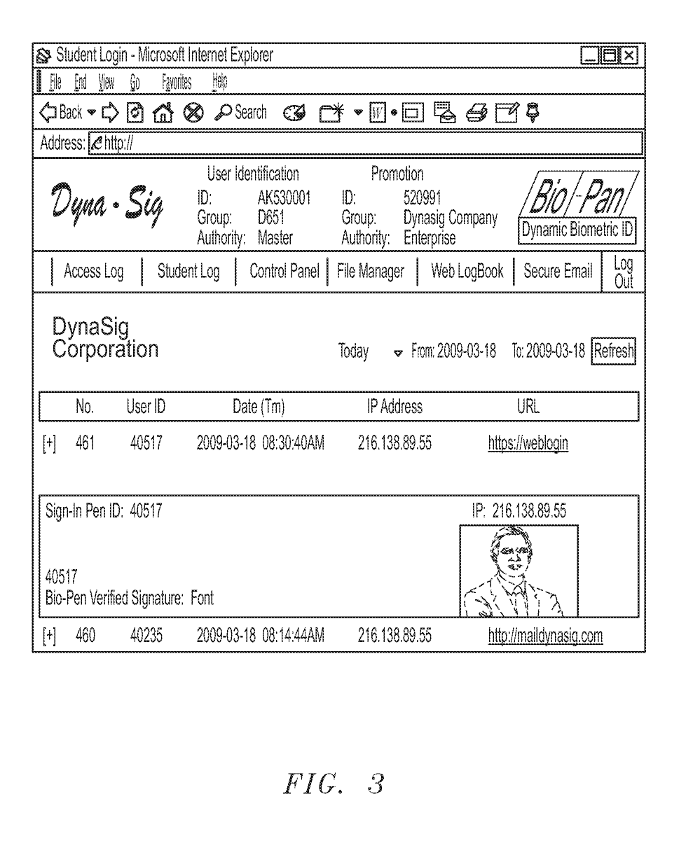

Once items have been added to the registry, the registry can be customized in a number of ways to afford protection to the owners of the items while providing access to viewers. For example, in one embodiment, the registered owner of the item can login to the memorabilia database and view their items at anytime but others cannot access those records. FIG. 3 shows one embodiment of a web page showing a registered user's items in the registry. In another embodiment, the registry entries may be viewed exclusively by the person or group of people who own the particular biometric pen that collected the autograph. In other embodiments, information in the registry may be filtered so that certain information is publicly available and other information is available only to the current owner. It should be appreciated that, in some cases it may be desirable to make information publicly available, such as when additional viewership may increase the value of an item, and in other cases it may be desirable to keep information regarding an item private, such as when certain information may be useful forensically in establishing the authenticity of the item.

In one example of how the registry may work, each registered user is issued a user ID. when a user logs into their account they can view information regarding the items that they own. If they are interested in selling an item, they can designate the item as “transfer enabled” or something similar. If the buyer is already a registered user, the seller can simply add the buyer's unique user ID and the new information is automatically updated in the registry. If the buyer is not a registered user, then the buyer must register with the registry and obtain a user ID and then complete the transfer.

It should be appreciated that ownership within the system may be anonymous, but that such anonymity would not affect the authentication of the item. For example, a registered user could register under a pseudonym, as long as you consistently access the system under the same name and user ID.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible registries and authentication systems, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for authenticating memorabilia comprising:
Assigning a first user ID to a first user of a registry;
inputting information regarding an item into a registry and recording the time and date of said entry in said registry;
assigning a unique item ID to said item, said item ID being associated with said first user ID;
upon the transfer of said item from said first user, changing said association of said first user ID from said first user to a second user of said registry.

2. The method of claim 1, wherein said information is the authentication of a signature on said item.

3. The method of claim 1, wherein said second user has been assigned a second user ID and, upon said transfer, said unique item ID is affiliated with said second user ID and is no longer affiliated with said first user ID.

4. The method of claim 1, wherein said first user may select whether or not to allow others to view items associated with said first user ID.

5. The method of claim 1, wherein said information is the authentication of a signature on said item and said authentication includes data generated through the use of a biometric pen.

6. The method of claim 1, wherein said information is the authentication of a signature on said item and said authentication includes video of the signing event.

7. The method of claim 1, wherein, prior to said transfer, said item is placed into escrow and said second user is allowed to view said item and any associated information.

8. A system for authenticating memorabilia comprising:
a registry; wherein each user of said registry is assigned a user ID;
a first user who is assigned a first user ID;
a second user;
an item of memorabilia; wherein information regarding said item is input into said registry and associated with said first user ID and the date and time of said input is recorded in said registry;
upon the transfer of said item from said first user, changing said association of said first user ID from said first user to said second user.

9. The system of claim 8, wherein said information is the authentication of a signature on said item.

10. The system of claim 8, wherein said second user has been assigned a second user ID and, upon said transfer, said unique item ID is affiliated with said second user ID and is no longer affiliated with said first user ID.

11. The system of claim 8, wherein said first user may select whether or not to allow others to view items associated with said first user ID.

12. The system of claim 8, wherein said information is the authentication of a signature on said item and said authentication includes data generated through the use of a biometric pen.

13. The system of claim 8, wherein said information is the authentication of a signature on said item and said authentication includes video of the signing event.

14. The system of claim 8, wherein, prior to said transfer, said item is placed into escrow and said second user is allowed to view said item and any associated information.

15. A method for authenticating memorabilia comprising:
means for associating a first user ID with a first user of a registry;
means for adding information regarding an item to the registry and recording the time and date of said addition;
means for associating said item with a unique item ID within said registry and for associating said item ID with said first user ID; and
means for associating said item ID with said second user upon the transfer of said item to said second user.
